(19) United States
(12) Patent Application Publication
(10) Pub. No.: US 2026/0172864 A1
(43) Pub. Date: Jun. 18, 2026

(54) METHODS FOR USING AUTOENCODERS FOR BEAM REPORTING

(71) Applicant: InterDigital Patent Holdings, Inc., Wilmington, DE (US)

(72) Inventors: Shahab Hamidi-Rad, Sunnyvale, CA (US); Young Woo Kwak, Woodbury, NY (US); Nazli Khan Beigi, Longueuil (CA); Patrick Tooher, Montreal (CA); Prasanna Herath, Laval (CA); Moon IL Lee, Melville, NY (US); Haseeb Ur Rehman, Winnipeg (CA); Yugeswar Deenoo Narayanan Thangaraj, Chalfont, PA (US)

(73) Assignee: InterDigital Patent Holdings, Inc., Wilmington, DE (US)

(21) Appl. No.: 18/985,432

(22) Filed: Dec. 18, 2024

(51) Int. Cl. H04W 24/10; H04B 7/06; H04B 17/318; H04L 41/16

(52) U.S. Cl. CPC H04W 24/10; H04B 7/0626; H04B 17/328; H04L 41/16

(57) ABSTRACT

A wireless transmit/receive unit (WTRU) comprises a processor configured to receive configuration information from a network that may include a set of reference signals (RSs) associated with a plurality of beams, an autoencoder configuration, and a channel state information (CSI) reporting configuration. The autoencoder configuration may include an autoencoder type. The autoencoder type may indicate that the autoencoder is configured without preprocessing, that the autoencoder is configured with a network configured threshold, or that the autoencoder is configured with a WTRU-indicated threshold. The processor may receive an indication of an autoencoder to be used for beam reporting, determine quality parameters associated with the set of RSs, and send a report that indicates a subset of the quality parameters to the network, wherein the subset of the quality parameters are indicated in the report based on the autoencoder and the autoencoder configuration.

### BACKGROUND

In traditional beam management (BM) procedure, beams in a cell were transmitted and measured to identify a best beam and receive channels and signals. However, in artificial intelligence (AI)/machine learning (ML) based downlink (DL) transmission (Tx) beam prediction, only a subset of resource sets corresponding to the selected beams are transmitted, and an AI/ML model may estimate qualities of other beams based on measurements of the selected beams. Use of AI/ML may serve as a strong foundation for enhancing conventional beam management aspects, such as predicting beams in time and/or spatial domain, reducing overhead and latency, improving beam selection accuracy, etc.

### SUMMARY

A wireless transmit/receive unit (WTRU) may comprise a processor. The processor may be configured to receive configuration information from a network. The configuration information may include, for example, a set of reference signals (RSs) associated with a plurality of beams, an autoencoder configuration, and a channel state information (CSI) reporting configuration. The autoencoder configuration may include, for example, an autoencoder type. The autoencoder type may indicate, for example, that the autoencoder is configured without preprocessing, that the autoencoder is configured with a network configured threshold, or that the autoencoder is configured with a WTRU-indicated threshold. The processor may be configured to receive an indication of an autoencoder to be used for beam reporting. The processor may be configured to determine quality parameters associated with the set of RSs. The processor may be configured to send a report that indicates a subset of the quality parameters to the network. The subset of the quality parameters may be indicated in the report based on the autoencoder and the autoencoder configuration.

When the autoencoder type indicates that the autoencoder is configured without preprocessing, the processor may be configured to indicate the subset of quality parameters in the report without preprocessing the quality parameters.

When the autoencoder type indicates that the autoencoder is configured with a network configured threshold, the processor may be configured to indicate the subset of quality parameters in the report that are associated with a subset of the plurality of beams based on the quality parameters for associated with the set of RSs and the network configured threshold.

When the autoencoder type indicates that the autoencoder is configured with a WTRU-indicated threshold, the processor may be configured to indicate the subset of quality parameters in the report that associated with a subset of the plurality of beams based on the quality parameters for associated with the set of RSs and the WTRU-indicated threshold.

The processor may be configured to determine an autoencoder evaluation procedure for the indicated autoencoder based on a training location of the autoencoder. During the autoencoder evaluation procedure, the processor may be configured to send a first indication of the subset of quality parameters based on the autoencoder and a second indication of the subset of quality parameters based on a legacy reporting method.

During the legacy reporting method, the processor may be configured to measure and report CSI reference signal resource indicator (CRI) and reference signal received power (RSRP) to the network.

The autoencoder configuration may include, for example, an indication of a preprocessing configuration for the autoencoder type or an autoencoder training indication. The report may indicate, for example, information based on the autoencoder type.

The quality parameters may include, for example, reference signal received power (RSRP) measurements of the set of RSs and signal-to-interference plus noise ratio (SINR) measurements of the set of RSs.

The processor may be configured to receive a second indication that indicates a second autoencoder to be used for CSI reporting. The processor may be configured to activate the autoencoder for reporting beam information.

A WTRU may be configured to perform a method that includes one or more of the following steps. The method may include receiving configuration information from a network. The configuration information may include, for example, a set of reference signals (RSs) associated with a plurality of beams, an autoencoder configuration, and a channel state information (CSI) reporting configuration. The autoencoder configuration may include, for example, an autoencoder type. The autoencoder type may indicate, for example, that the autoencoder is configured without preprocessing, that the autoencoder is configured with a network configured threshold, or that the autoencoder is configured with a WTRU-indicated threshold. The method may include receiving an indication of an autoencoder to be used for beam reporting. The method may include determining quality parameters associated with the set of RSs. The method may include sending a report that indicates a subset of the quality parameters to the network. The subset of the quality parameters may be indicated in the report based on the autoencoder and the autoencoder configuration.

When the autoencoder type indicates that the autoencoder is configured without preprocessing, the method may include indicating the subset of quality parameters in the report without preprocessing the quality parameters.

When the autoencoder type indicates that the autoencoder is configured with a network configured threshold, the method may include indicating the subset of quality parameters in the report that are associated with a subset of the plurality of beams based on the quality parameters for associated with the set of RSs and the network configured threshold.

When the autoencoder type indicates that the autoencoder is configured with a WTRU-indicated threshold, the method may include indicating the subset of quality parameters in the report that associated with a subset of the plurality of beams based on the quality parameters for associated with the set of RSs and the WTRU-indicated threshold.

The method may include determining an autoencoder evaluation procedure for the indicated autoencoder based on a training location of the autoencoder. During the autoencoder evaluation procedure, the method may include sending a first indication of the subset of quality parameters based on the autoencoder and a second indication of the subset of quality parameters based on a legacy reporting method.

During the legacy reporting method, the method may include measuring and reporting CSI reference signal resource indicator (CRI) and reference signal received power (RSRP) to the network.

The autoencoder configuration may include, for example, an indication of a preprocessing configuration for the autoencoder type and/or an autoencoder training indication. The report may indicate, for example, information based on the autoencoder type.

The quality parameters may include, for example, reference signal received power (RSRP) measurements of the set of RSs and signal-to-interference plus noise ratio (SINR) measurements of the set of RSs.

The method may include receiving a second indication that indicates a second autoencoder to be used for CSI reporting. The method may include activating the autoencoder for reporting beam information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart illustrating an example procedure for using autoencoders for beam reporting according to an embodiment.

### DETAILED DESCRIPTION

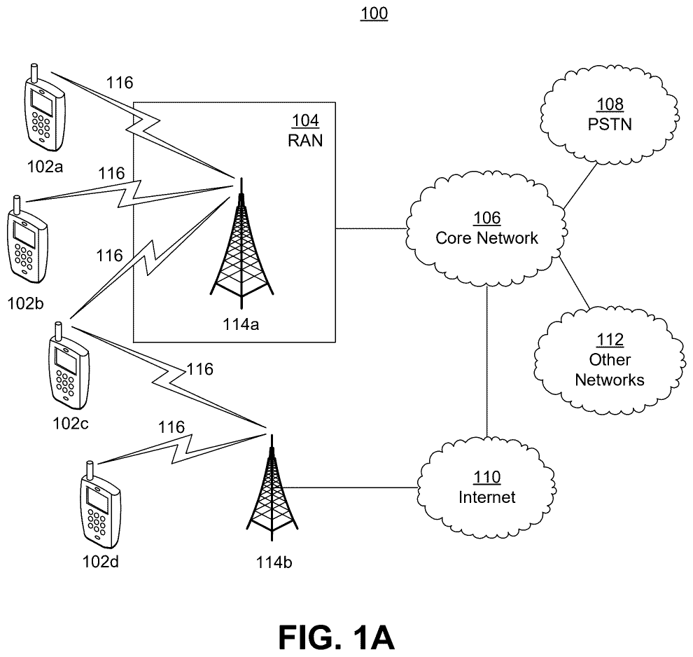

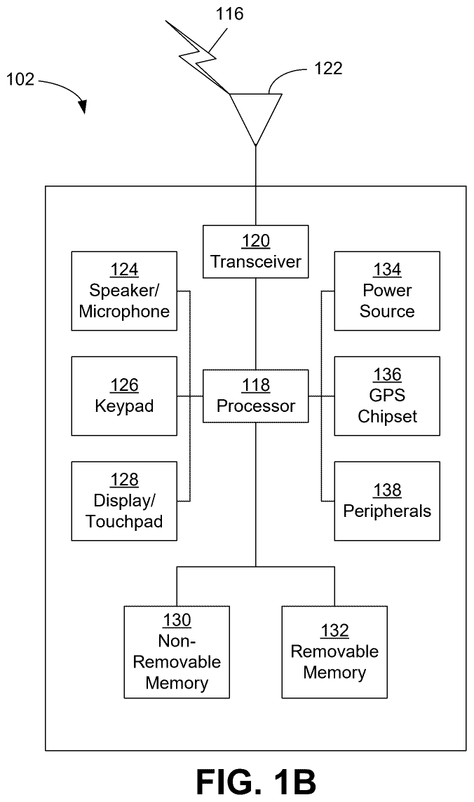

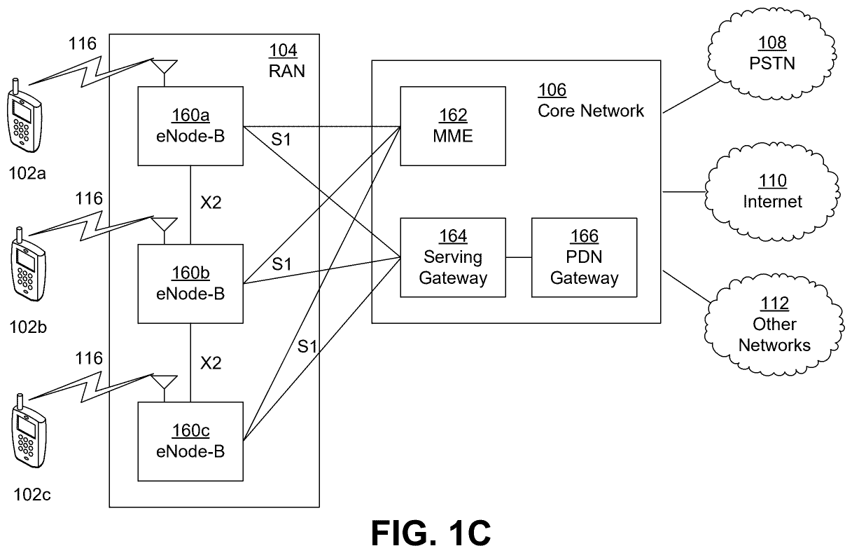

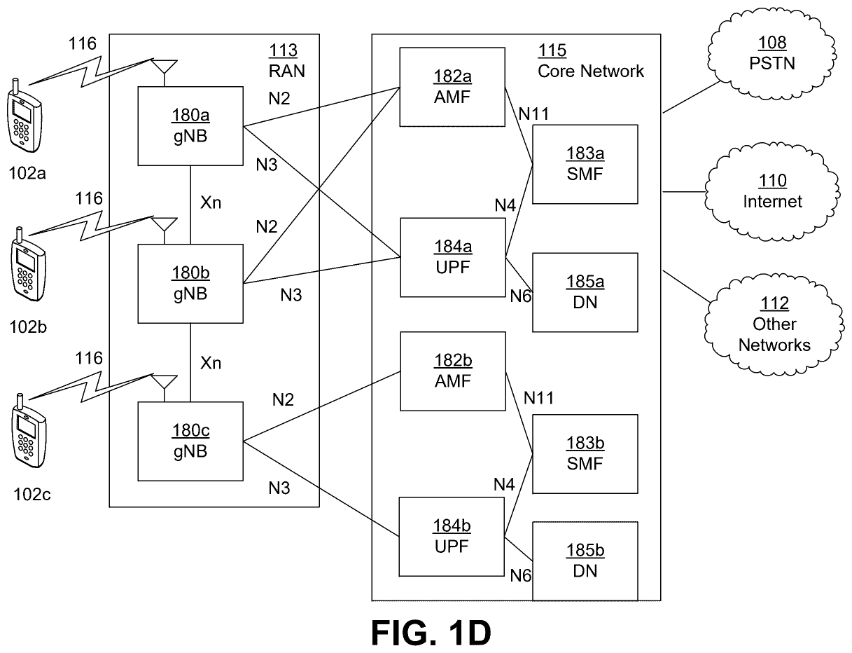

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S 1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an autoencoder for beam reporting to compress the information more efficiently and reduce the WTRU reporting overhead may be implemented. For example, a method may include receiving configuration for an autoencoder-based beam reporting. A method may include, for example, training the autoencoder(s) at the WTRU and/or gNB. A method may include using the encoder part of the trained autoencoder to encode measured beam information. A method may include monitoring the performance of the autoencoder during the inference.

Work items related to AL/ML for new radio (NR) Air Interface may have the following objectives for beam management. In some examples, an objective for beam management (e.g., DL Tx beam prediction for both wireless transmit/receive unit (WTRU)-sided model and network (NW)-sided model may include, for example, spatial-domain DL Tx beam prediction for set A of beams based on measurement results of set B of beams (e.g., BM-Case1). An objective for beam management may include, for example, temporal DL Tx beam prediction for set A of beams based on the historic measurement results of set B of beams (e.g., BM-Case2). An objective for beam management may include, for example, specifying necessary signaling and/or mechanism(s) to facilitate life cycle management (LCM) operations specific to the BM use cases, if any. An objective for beam management may include, for example, enabling method(s) to ensure consistency between training and inference regarding NW-side additional conditions, if identified, for inference at WTRU. An objective for beam management may include, for example, striving for common framework design to support both BM-Case1 and BM-Case2.

The use case for AI/ML with respect to beam management may be to predict one or more best beams of among a set of beams with more accuracy and less overhead than legacy beam management procedures. Another use case for AI/ML with respect to beam management may be to predict qualities of beams including unmeasured beams based on the measured qualities of beams. In some examples, the reference signals (RSs) associated with a beam may be measured by the WTRU to determine the beam quality and a best beam(s) are reported among the measured beams. In some examples, an AI/ML model in a WTRU and/or gNB may predict one or more beams out of all possible beams including those not measured by the WTRU and/or gNB. In some examples, an AI/ML model may predict beam qualities of unmeasured beams. The input to the AI/ML model may be a set of beam measurements associated with a set of reference signals. The input set may be denoted by set B. The AI/ML model may predict a best beam (e.g., a beam index) and/or qualities of beams from an output predicted set of beams, denoted by set A. Set B may be a subset of set A. An AI/ML model at the NW-side may need beam IDs and beam measurements by the WTRU as input to the model for performing training and inference. For WTRU-side modeling, the WTRU may periodically transmit a beam report which contains the Top-K predicted beam IDs. The WTRU may also periodically transmit measurements associated with set A (e.g., prediction set), which may result in a huge reporting overhead for the WTRU, especially for the BM-case2 wherein the measurement set (e.g., set B) is large. A procedure to efficiently indicate and/or report beam IDs in a beam report is needed so that reporting overhead is minimized.

Autoencoders are known for their ability to efficiently learn patterns within the data. By leveraging these learned patterns, autoencoders may compress information more effectively. In some examples, autoencoders may be used to compress the beam information transmitted by the WTRU, which may reduce the beam reporting overhead.

In current specification for beam management, the RSs associated with a beam may be measured by the WTRU to determine the beam quality and a best beam(s) are reported among the measured beams. The example methods discussed herein may describe how to reduce beam reporting overhead using autoencoders. The WTRU may determine methods to encode the beam qualities and monitor performance by using an autoencoder based on the type of an indicated autoencoder and training position.

In some examples, the WTRU may receive a configuration. The configuration may include, for example, RSs associated with set B, and/or set A and set B for training. The configuration may include configuration of performance evaluation (e.g., a channel state information (CSI) reporting configuration, so that WTRU reporting of performance evaluation results may be configured). The configuration may include one or more autoencoder configurations. In some examples, the autoencoder configuration may include autoencoder type (e.g., without preprocessing, autoencoder with gNB configured threshold and/or autoencoder with WTRU indicated threshold). In some examples, the autoencoder configuration may include preprocessing related configuration according to the configured autoencoder type. For example, if the “autoencoder type=without preprocessing”, the WTRU may not receive preprocessing related configuration. If the “autoencoder type=with gNB configured threshold”, the WTRU may receive a configuration of threshold for preprocessing (e.g. X dB) and a maximum number of beams (e.g., M1) to be reported. If the “autoencoder type=with a WTRU determined threshold”, the WTRU may receive ranges of a threshold for preprocessing (e.g., X1-X2 dB) and a maximum number of beams (e.g., M2) to be reported. In some examples, the autoencoder configuration may include autoencoder training (e.g., WTRU-Trained, gNB-Trained, Shared-Dataset, Referenced-Autoencoder).

In some examples, the WTRU may receive an indication of an autoencoder to be used (e.g., for each CSI reporting configuration) for beam management (e.g., via medium access control-control element (MAC-CE)). In some examples, based on the indicated autoencoder and the configured autoencoder training, the WTRU may determine the encoder part of the autoencoder. For example, if the “autoencoder training=WTRU-Trained”, after training the autoencoder, the WTRU may keep the encoder part and may send the decoder part of the trained autoencoder to the gNB. If the “autoencoder training=gNB-Trained”, the WTRU may receive the encoder part from gNB. If the “autoencoder training=Shared-Dataset”, after training the autoencoder (e.g., using a shared dataset and/or an alignment method), the WTRU may keep the encoder part (e.g., no need to send the decoder part to the gNB). If the “autoencoder training=Referenced-Autoencoder”, after training the autoencoder (e.g., using a referenced autoencoder), the WTRU may keep the encoder part (e.g., no need to send the decoder part to the gNB).

In some examples, the WTRU may activate the indicated autoencoder for reporting beam information. In some examples, the WTRU may perform measurements on RSs associated to Set B and may determine qualities (e.g., reference signal received power (RSRP), signal-to-interference and plus noise ratio (SINR), etc.) of the RSs associated to Set B.

In some examples, based on the indicated autoencoder and/or type of the indicated autoencoder, the WTRU may indicate the determined qualities to the gNB. For example, if the “autoencoder type=without preprocessing”, the WTRU may encode the determined qualities by a given encoder without preprocessing. If the “autoencoder type=with a gNB configured threshold”, the WTRU may determine a best beam and one or more beams in set B within X dB margin from the best beam. For instance, if the number of the one or more beams in set B is greater than M1 (e.g., max. number of beams), the WTRU may determine M1 beams with highest qualities from the one or more beams. For instance, the WTRU may encode measured quality of the best beam, measured qualities of the one or more beams and/or unmeasured qualities (e.g., RSRP_0) for the beams in set B other than the best beam and the one or more beams. If the “autoencoder type=with WTRU determined threshold”, the WTRU may determine a best beam and a threshold, Y dB, within the configured ranges (e.g., X1-X2 dB). For instance, the WTRU may determine one or more beams in set B within Y dB margin from the best beam. For instance, if the number of the one or more beams in set B is greater than M2 (e.g., max. number of beams), the WTRU may determine M2 beams with highest qualities from the one or more beams. For instance, the WTRU may encode measured quality of the best beam, measured qualities of the one or more beams and/or unmeasured qualities (e.g., RSRP_0) for the beams in set B other than the best beam and the one or more beams.

In some examples, the WTRU may indicate information based on the autoencoder type. For example, if the “autoencoder type=without preprocessing” and/or with “gNB configured threshold”, the WTRU may indicate the encoded information. For example, if autoencoder type=with WTRU determined threshold”, and if the WTRU determined the threshold (Y dB), the WTRU may indicate one or more of successful determination of Y dB and/or a type of WTRU information, the determined threshold, and/or the encoded information. Otherwise, the WTRU may indicate the determined qualities, as stated above and herein (e.g., RSRP, SINR, etc.) in legacy reporting methods (e.g., CSI reference signal resource indicator (CRIs) and RSRPs).

In some examples, based on the configuration of performance evaluation, the WTRU may determine autoencoder evaluation procedure for each autoencoder of one or more of the configured autoencoders based on training location of the autoencoder. For example, if the autoencoder training is gNB-trained, Shared-Dataset, and/or Referenced-Autoencoder, the WTRU may determine a first type of performance evaluation procedure (e.g., gNB side evaluation). In another example, if the type of autoencoder is gNB-trained, the WTRU may determine a first type of performance evaluation procedure (e.g., gNB side evaluation). For instance, the WTRU may indicate measured qualities with both encoded information by using the autoencoder and/or legacy reporting method (e.g., CRIs and RSRPs). In some examples, the WTRU may compare size of the outputs from the configured autoencoders and indicates information of N autoencoders with smallest output sizes.

For example, if the autoencoder training is WTRU-trained and/or if the type of autoencoder is WTRU-trained, the WTRU may determine a second type of performance monitoring procedure (e.g., WTRU side evaluation). For instance, the WTRU may encode the determined qualities based on the type of autoencoder. The WTRU may decode the information (e.g., by using WTRU's decoder) and may compare the results with the determined qualities. The WTRU may indicate the information about the performance of the autoencoder (e.g., mean square error (MSE) between the decoded qualities and the original qualities and/or size of output from the autoencoder). In some examples, the WTRU may indicate a preferred encoder based on the performance of the autoencoder.

In some examples, based on the indicated information, the WTRU may receive an indication of an autoencoder to be used (e.g., for each CSI reporting configuration) and/or the legacy reporting method to be used (e.g., CRIs and RSRPs) for beam management (e.g., via MAC-CE). In some examples, the WTRU may activate the indicated autoencoder for reporting beam information and/or switches to the specified legacy beam reporting method.

The example methods herein may enable the utilization of autoencoders to reduce the beam-reporting overhead in different configurations, by capturing the patterns and/or efficiently compressing the beam reports.

Artificial intelligence (AI) may be broadly defined as the behavior exhibited by machines. Such behavior may, for example, mimic cognitive functions to sense, reason, adapt and act. Machine learning may refer to the type of algorithms that solve a problem based on learning through experience (‘data’), without explicitly being programmed (‘configuring set of rules’). Machine learning (ML) may be considered as a subset of AI. Different machine learning paradigms may be envisioned based on the nature of data or feedback available to the learning algorithm. For example, a supervised learning approach may involve learning a function that maps input to an output based on a labeled training example, wherein each training example may be a pair consisting of input and the corresponding output. For example, unsupervised learning approach may involve detecting patterns in the data with no pre-existing labels. For example, the reinforcement learning approach may involve performing sequence of actions in an environment to maximize the cumulative reward. In some examples, it is possible to apply machine learning algorithms using a combination and/or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. DNNs have shown state-of-the-art performance in variety of domains, for example, speech, vision, natural language etc. and for various machine learning settings supervised, unsupervised, and semi-supervised. The term AI/ML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit and/or receive a physical channel and/or reference signal according to at least one spatial domain filter. The term “beam” may be used to refer to a spatial domain filter. The WTRU may transmit a physical channel and/or signal using the same spatial domain filter as the spatial domain filter used for receiving an RS (such as CSI-RS) or a synchronization signal (SS) block. The WTRU transmission may be referred to as “target”, and the received RS and/or SS block may be referred to as “reference” or “source”. In such case, the WTRU may be said to transmit the target physical channel or signal according to a spatial relation with a reference to such RS and/or SS block. The WTRU may transmit a first physical channel and/or signal according to the same spatial domain filter as the spatial domain filter used for transmitting a second physical channel or signal. The first and second transmissions may be referred to as “target” and “reference” or “source”, respectively. In such case, the WTRU may be said to transmit the first (target) physical channel or signal according to a spatial relation with a reference to the second (reference) physical channel or signal. A spatial relation may be implicit, configured by radio resource control (RRC) and/or signaled by MAC-CE and/or downlink control information (DCI). For example, a WTRU may implicitly transmit physical uplink shared channel (PUSCH) and demodulation (DM)-RS of PUSCH according to the same spatial domain filter as an sounding reference signal (SRS) indicated by an SRS resource indicator (SRI) indicated in DCI and/or configured by RRC. In another example, a spatial relation may be configured by RRC for an SRS resource indicator (SRI) and/or signaled by MAC-CE for a physical uplink control channel (PUCCH). Such spatial relation may also be referred to as a “beam indication”. The WTRU may receive a first (target) downlink channel and/or signal according to the same spatial domain filter and/or spatial reception parameter as a second (e.g., reference) downlink channel and/or signal. For example, such association may exist between a physical channel such as physical downlink control channel (PDCCH) and/or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC-CE. Such indication may also be referred to as a “beam indication”.

A transmission and reception point (TRP) may be interchangeably used with one or more of transmission point (TP), reception point (RP), radio remote head (RRH), distributed antenna (DA), base station (BS), a sector (e.g., of a BS), and a cell (e.g., a geographical cell area served by a BS), but still consistent with this invention. Hereafter, multi-TRP may be interchangeably used with one or more of MTRP, M-TRP, and multiple TRPs, but still consistent with the methods and/or apparatuses described herein.

A WTRU may report a subset of channel state information (CSI) components, where CSI components may correspond to at least a CSI-RS resource indicator (CRI), a synchronization signal block resource indicator (SSBRI), an indication of a panel used for reception at the WTRU (e.g., a panel identity or group identity), measurements such as L1-RSRP, L1-SINR taken from synchronization signal block (SSB) and/or CSI-RS (e.g., cri-RSRP, cri-SINR, ssb-Index-RSRP, ssb-Index-SINR), and/or other channel state information such as at least rank indicator (RI), channel quality indicator (CQI), precoding matrix indicator (PMI), layer Index (LI), etc.

Channel and/or interference measurements may be implemented. A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, and/or attempt to decode an SSB during initial access, initial synchronization, radio link monitoring (RLM), cell search, cell switching, etc.

In some examples, a WTRU may measure and/or report the channel state information (CSI), wherein the CSI for each connection mode may include and/or be configured with one or more of following. For example, the CSI for each connection mode may include and/or be configured with CSI report configuration. CSI report configuration may include one or more of the following. For instance, the CSI report configuration may include a CSI report quantity, for example, Channel Quality Indicator (CQI), Rank Indicator (RI), Precoding Matrix Indicator (PMI), CSI-RS Resource Indicator (CRI), Layer Indicator (LI), etc. The CSI report configuration may include a CSI report type (e.g., aperiodic, semi persistent, periodic). The CSI report configuration may include CSI report codebook configuration (e.g., Type I, Type II, Type II port selection, etc.). The CSI report configuration may include a CSI report frequency.

For example, the CSI for each connection mode may include and/or be configured with CSI-RS resource set, including one or more of the following CSI resource settings. For instance, the CSI-RS resource set may include nonzero power (NZP)-CSI-RS resource for channel measurement as a CSI resource setting. The CSI-RS resource set may include NZP-CSI-RS resource for interference measurement as a CSI resource setting. The CSI-RS resource set may include zero power (ZP)-CSI-RS resource for interference measurement as a CSI resource setting. The CSI-RS resource set may include CSI interference measurement (IM) resource for interference measurement as a CSI resource setting.

For example, the CSI for each connection mode may include and/or be configured with NZP CSI-RS resources. NZP CSI-RS resources may include one or more of the following. For instance, NZP CSI-RS resources may include NZP CSI-RS resource ID. NZP CSI-RS resources may include periodicity and offset. NZP CSI-RS resources may include QCL information and TCI-state. NZP CSI-RS resources may include resource mapping (e.g., number of ports, density, CDM type, etc.).

In some examples, a WTRU may indicate, determine, and/or be configured with one or more reference signals. The WTRU may monitor, receive, and/or measure one or more parameters based on the respective reference signals. For example, one or more of the following may apply. The following parameters are non-limiting examples of the parameters that may be included in reference signal(s) measurements. One or more of these parameters may be included. Other parameters may be included. For instance, the WTRU may monitor, receive, and/or measure SS reference signal received power (SS-RSRP). SS-RSRP may be measured based on the synchronization signals (e.g., DM-RS in PBCH and/or SSS). SS-RSRP may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals. For instance, the WTRU may monitor, receive, and/or measure CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

For instance, the WTRU may monitor, receive, and/or measure SS-SINR. SS-SINR may be measured based on the synchronization signals (e.g., DM-RS in PBCH or SSS). SS-SINR may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers. The WTRU may monitor, receive, and/or measure CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS. The WTRU may monitor, receive, and/or measure received signal strength indicator (RSSI). RSSI may be measured based on the average of the total power contribution in configured orthogonal frequency division multiplexing (OFDM) symbols and bandwidth. The power contribution may be received from different resources (e.g., co-channel serving and non-serving cells, adjacent channel interference, thermal noise, etc.). The WTRU may monitor, receive, and/or measure cross-layer interference received signal strength indicator (CLI-RSSI). CLI-RSSI may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, etc.). The WTRU may monitor, receive, and/or measure sounding reference signals RSRP (SRS-RSRP). SRS-RSRP may be measured based on the linear average over the power contribution of the resource elements (RE) that carry the respective SRS.

In some examples a beam and/or CSI report configuration (e.g., CSI-ReportConfigs) may be associated with a single bandwidth part (BWP) (e.g., indicated by BWP-Id), wherein one or more of the following parameters are configured. For example, CSI-RS resources and/or CSI-RS resource sets for channel and interference measurement may be configured. CSI-RS report configuration type including the periodic, semi-persistent, and aperiodic may be configured. CSI-RS transmission periodicity for periodic and semi-persistent CSI reports may be configured. CSI-RS transmission slot offset for periodic, semi-persistent and aperiodic CSI reports may be configured. CSI-RS transmission slot offset list for semi-persistent and aperiodic CSI reports may be configured. Time restrictions for channel and interference measurements may be configured. Report frequency band configuration (wideband/subband CQI, PMI, etc.) may be configured. Thresholds and modes of calculations for the reporting quantities (CQI, RSRP, SINR, LI, RI, etc.) may be configured. Codebook configuration, group based beam reporting. CQI table, subband size, non-precoding matrix indicator (PMI) port indication and/or port index may be configured.

In some examples, a CSI-RS Resource Set (e.g., NZP-CSI-RS-ResourceSet) may include one or more of CSI-RS resources (e.g., NZP-CSI-RS-Resource and CSI-ResourceConfig). A WTRU may be configured with one or more of the following in a CSI-RS Resource. For example, a WTRU may be configured with CSI-RS periodicity and slot offset for periodic and semi-persistent CSI-RS Resources. A WTRU may be configured with CSI-RS resource mapping to define the number of CSI-RS ports, density, CDM-type, OFDM symbol, and/or subcarrier occupancy. A WTRU may be configured with the bandwidth part to which the configured CSI-RS is allocated. A WTRU may be configured with the reference to the TCI-State including the QCL source RS(s) and the corresponding QCL type(s).

In some examples, one or more of following configurations may be used for a RS resource set. For example, a WTRU may be configured with one or more RS resource sets. The RS resource set configuration may include one or more of following. For instance, the RS resource set configuration may include a RS resource set ID. The RS resource set configuration may include one or more RS resources for the RS resource set. The RS resource set configuration may include repetition (e.g., on or off). The RS resource set configuration may include aperiodic triggering offset (e.g., one of 0-6 slots). The RS resource set configuration may include tracking reference signal (TRS) information (e.g., true or not).

In some examples, one or more of following configurations may be used for RS resource. For example, a WTRU may be configured with one or more RS resources. The RS resource configuration may include one or more of following. For instance, the RS resource configuration may include RS resource ID. The RS resource configuration may include resource mapping (e.g., REs in a physical resource block (PRB)). The RS resource configuration may include power control offset (e.g., one value of −8, . . . , 15). The RS resource configuration may include power control offset with SS (e.g., −3 dB, 0 dB, 3 dB, 6 Db). The RS resource configuration may include scrambling ID. The RS resource configuration may include periodicity and offset. The RS resource configuration may include QCL information (e.g., based on a TCI state).

In some examples, a property of a grant or assignment may consist of at least one of the following. For example, a property of a grant or assignment may consist of a frequency allocation. A property of a grant or assignment may consist of an aspect of time allocation, such as a duration. A property of a grant or assignment may consist of a priority. A property of a grant or assignment may consist of a modulation and coding scheme. A property of a grant or assignment may consist of a transport block size. A property of a grant or assignment may consist of a number of spatial layers. A property of a grant or assignment may consist of a number of transports blocks. A property of a grant or assignment may consist of a TCI state, CRI and/or SRI. A property of a grant or assignment may consist of a number of repetitions. A property of a grant or assignment may consist of whether the repetition scheme is type A or type B. A property of a grant or assignment may consist of whether the grant is a configured grant type 1, type 2 or a dynamic grant. A property of a grant or assignment may consist of whether the assignment is a dynamic assignment or a semi-persistent scheduling (e.g., configured) assignment. A property of a grant or assignment may consist of a configured grant index or a semi-persistent assignment index. A property of a grant or assignment may consist of a periodicity of a configured grant or assignment. A property of a grant or assignment may consist of a channel access priority class (CAPC). A property of a grant or assignment may consist of any parameter provided in a DCI, by MAC and/or by RRC for the scheduling the grant or assignment.

In some examples, an indication by DCI may consist of at least one of the following. For example, an indication by DCI may consist of an explicit indication by a DCI field or by radio network temporary identifier (RNTI) used to mask the cyclic redundancy check (CRC) of the PDCCH. An indication by DCI may consist of an implicit indication by a property such as DCI format, DCI size, control resource set (CORESET) and/or search space, aggregation level, first resource element of the received DCI (e.g., index of first control channel element), where the mapping between the property and the value may be signaled by RRC or MAC.

In some examples, RS may be interchangeably used with one or more of RS resource, RS resource set, RS port and RS port group, but still consistent with the methods and/or apparatuses described herein. In some examples, RS may be interchangeably used with one or more of SSB, CSI-RS, SRS, DM-RS, TRS, positioning reference signal (PRS), and phase tracking reference signal (PTRS), but still consistent with the methods and/or apparatuses described herein.

In some examples, a reference signal may be interchangeably used with one or more of following but still consistent with the methods and/or apparatuses described herein. For example, a reference signal may be interchangeably used with sounding reference signal (SRS). A reference signal may be interchangeably used with channel state information - reference signal (CSI-RS). A reference signal may be interchangeably used with demodulation reference signal (DM-RS). A reference signal may be interchangeably used with phase tracking reference signal (PT-RS). A reference signal may be interchangeably used with A reference signal may be interchangeably used with synchronization signal block (SSB).

In some examples, a channel may be interchangeably used with one or more of following but still consistent with the methods and/or apparatuses described herein. For example, a channel may be interchangeably used with PDCCH. A channel may be interchangeably used with PDSCH. A channel may be interchangeably used with physical uplink control channel (PUCCH). A channel may be interchangeably used with physical uplink shared channel (PUSCH). A channel may be interchangeably used with physical random access channel (PRACH).

In some examples, a key performance indicator (KPI) may refer to one or more of the following. For example, a KPI may refer to signal quality (e.g., L1-RSRP, SINR, CQI, RSSI, RSRQ). A KPI may refer to prediction performance (e.g., percentage of the Top-1 genie-aided (e.g., best) beam is one of the Top-K predicted beams). A KPI may refer to link quality (e.g., throughput, block error rate (BLER)). A KPI may refer to data distribution (e.g., mean and/or variance of measured and/or predicted beam measurements). A KPI may refer to RSRP (e.g., L1-RSRP) difference (i.e., the difference between measured and predicted RSRP of a beam).

In some examples, a signal, channel, and/or message (e.g., as in DL and/or uplink (UL) signal, channel, and message) may be used interchangeably, but still consistent with the methods and/or apparatuses described herein. A RS resource set may be interchangeably used with an RS resource and a beam group, but still consistent with the methods and/or apparatuses described herein. A RS resource set may be interchangeably used with a beam group, but still consistent with the methods and/or apparatuses described herein. Beam reporting may be interchangeably used with CSI measurement, CSI reporting and beam measurement, but still consistent with the methods and/or apparatuses described herein.

In some examples, the example methods described herein for beam resources prediction may be used for beam resources belonging to a single and/or multiple cells as well as single or multiple TRPs, and still consistent with the methods and/or apparatuses described herein. CSI reporting may be interchangeably used with CSI measurement, beam reporting and beam measurement, but still consistent with the methods and/or apparatuses described herein.

In some examples, a set B may be interchangeably used with a set of RS resource sets, beams, beam-pairs, beam RS resources, RS resources and a beam pattern. A set B may be interchangeably used with measurement RS resources, measurement RS resource set, measurement beam resources, measurement beam resource set, measurement beam pattern, measurement TCI states, and/or measurement TCI state group, etc., but still consistent with the methods and/or apparatuses described herein. A set A may be interchangeably used with a set of RS resource sets, beams, beam-pairs, beam RS resources, RS resources, and a beam pattern.

In some examples, beam prediction accuracy may be interchangeably used with prediction accuracy, the methods and/or apparatuses described herein. An autoencoder may be interchangeably used with an autoencoder configuration and CSI report configuration for an autoencoder, but still consistent with the methods and/or apparatuses described herein.

Methods to configure measurement resources, autoencoder types, and autoencoder training position may be implemented. In some examples, a WTRU may receive a resource set configuration of one or more of the following (e.g., via RRC, MAC-CE and/or DCI). For example, a WTRU may receive a resource configuration of one RS resource set wherein one or more RS resources associated to the RS resource set may be associated to one or more of set B, set A and neither (e.g., not with set A nor set B). For instance, the association of an RS resource with set B and/or set A may be configured via RRC (e.g., via one or more parameters inside RS-ResourceConfig and/or RS-ResourceSetConfig), MAC-CE, and/or DCI (e.g., a bitmap-based activation/indication of association of RS resources with set B and/or set A).

For example, a WTRU may receive a resource configuration of two or more RS resource sets wherein each RS resource set is associated to either set B and/or set A. For instance, one resource set for set A may be used for indicating beam information (e.g., one or more of CRI, RI and/or logical beam ID) and/or corresponding predicted/measured qualities (e.g., one or more of RSRP, RSRQ and SINR). Another resource set for set B may be used for measuring beam information (e.g., input for AI/ML model inference).

CSI report configuration may be implemented. In some examples, a WTRU may receive one or more CSI report configurations wherein each CSI report configuration may be associated with one or more autoencoder configurations. For example, the WTRU may receive an indication of IDs for the autoencoder configurations associated with each CSI report configuration. The indication may be via one or more of RRC, MAC-CE and/or DCI. In some examples, a WTRU may receive a configuration of a parameter related to beam/CSI reporting for autoencoder for reportQuantity within each CSI report configuration.

Autoencoder configuration may be implemented. In some examples, a WTRU may receive one or more autoencoder configurations wherein a first configuration may indicate the configuration of the first autoencoder. A second configuration may indicate the configuration of the second autoencoder, etc.

In some examples, each one of the one or more autoencoder configurations may include one or more of the following parameters. For example, the autoencoder configurations may include autoencoder type. The WTRU may receive an indication and/or configuration parameter indicating the type of autoencoders wherein a first value of the parameter may indicate the first autoencoder type. A second value may indicate the second autoencoder type, etc. For example, the value of the indicated and/or configured autoencoder type may be one of the following. For instance, the value of the indicated and/or configured autoencoder type may be an autoencoder without preprocessing. This value (e.g., autoencoder without preprocessing) may be used to indicate that the WTRU does not preprocess the measured qualities before encoding them using the indicated and/or configured autoencoder's encoder module. For instance, the value of the indicated and/or configured autoencoder type may be an autoencoder with gNB-configured threshold. This value (e.g., autoencoder with gNB-configured threshold) may be used to indicate that the WTRU preprocesses the measured qualities using the indicated and/or configured threshold value (e.g. X dB) from the highest quality beam/RS. For instance, the value of the indicated and/or configured autoencoder type may be an autoencoder with WTRU-indicated threshold. This value (e.g., autoencoder with WTRU-indicated threshold) may be used to indicate that the WTRU first determines a threshold value from a gNB-configured range of thresholds (e.g. X1-X2 dB) from the highest quality beam/RS, and then use the determined threshold value to preprocess the measured qualities.

For example, the autoencoder configurations may include autoencoder training. The WTRU may receive an indication and/or configuration parameter indicating where and/or how the autoencoder is trained (e.g. WTRU-trained, gNB-trained, etc.) wherein a first value of the parameter may indicate the first autoencoder training (e.g. WTRU-trained). A second value may indicate the second autoencoder training (e.g. gNB-trained), etc. For example, the value of the indicated and/or configured autoencoder training parameter may be one of the following. For instance, the value of the indicated and/or configured autoencoder training parameter may be WTRU-trained. This value (e.g., WTRU-trained) may be used to indicate the autoencoder is trained at the WTRU. For instance, the value of the indicated and/or configured autoencoder training parameter may be gNB-trained. This value (e.g., gNB-trained) may be used to indicate the autoencoder is trained at the gNB. For instance, the value of the indicated and/or configured autoencoder training parameter may be shared-data. This value (e.g., shared-data) may be used to indicate the autoencoder is trained both at the WTRU and/or gNB. In one example, the WTRU may also be configured with an alignment method that may be used during the training of the autoencoder. For instance, the value of the indicated and/or configured autoencoder training parameter may be referenced-autoencoder. This value (e.g., referenced-autoencoder) may be used to indicate the autoencoder is trained both at the WTRU and/or gNB using a reference autoencoder. In one example, the WTRU may also be configured with an indication of a reference autoencoder (e.g. a URL) that may be used during the training of the autoencoder.

For example, the autoencoder configurations may include autoencoder mask value. The WTRU may receive an indication and/or configuration parameter indicating the masked value used in place of beams in the report that do not have a measured quality. For example, for RSRP beam values, the WTRU may be configured to use a fixed value from the quantization table (e.g. RSRP_0) for the masked beams.

For example, the autoencoder configurations may include a reference autoencoder. The WTRU may receive an indication and/or configuration parameter indicating the reference autoencoder that may be used during training, depending on the value of the autoencoder training, wherein the value of the parameter may be a URL to download the reference autoencoder. The autoencoder configurations may include an autoencoder alignment method. The WTRU may receive an indication and/or configuration parameter indicating the method used for alignment of the encoder and decoder that may be used during training, depending on the value of the autoencoder training.

For example, the autoencoder configurations may include thresholds. In some examples, the WTRU may be configured with one or more RS/beam quality, and/or RS/beam selection thresholds. For example, the WTRU may be configured with a RSRP-threshold, and/or a threshold of X dB margin from the highest quality beam/RS. For example, the WTRU may be configured with one or more thresholds for RSRP, RSRQ, line of sight (LOS) probability, CQI, SINR, hypothetical BLER, etc. In some examples, the WTRU may be configured with a range of threshold values, wherein the range may indicate the minimum and maximum values for the threshold. For example, a range of threshold values may be the range for RSRP-threshold, and/or a threshold range of X1-X2 dB margin from the highest quality beam/RS. For example, the WTRU may be configured with the range for one or more thresholds for RSRP, RSRQ, LOS probability, CQI, SINR, hypothetical BLER, etc.

For example, the autoencoder configurations may include “max number of beams”. In some examples, the WTRU may be configured with one or more indication and/or configuration parameters indicating the maximum number of beam information included in the encoded beam report. For example, a “max number of beams” may indicate the maximum number of beams (e.g., M1), when a single threshold value is configured. For example, another “max number of beams” may indicate the maximum number of beams (e.g., M2), when a range of threshold values is configured.

In some examples, the WTRU may receive the values of one or more of the parameters (“Autoencoder Type”, “Autoencoder training”, “Autoencoder Mask value”, “Reference Autoencoder”, alignment method, threshold, threshold range, and “Max Number of Beams”) via system information block (SIB), RRC, MAC-CE, DCI, etc., for example from a gNB. In some examples, the WTRU may receive an indication of the autoencoder to be used for beam reporting (e.g., from the one or more configured autoencoders). For example, the WTRU may receive an index associated with a configuration of the one or more autoencoder configurations. The indication may be based on one or more of SIB, RRC, MAC-CE and/or DCI.

Autoencoder training and interoperability may be implemented. In some examples, a WTRU may determine, be configured, and/or indicated to use one or more autoencoders. Based on the determined, configured, and/or indicated one or more autoencoders, the WTRU may determine a procedure for encoders of the indicated one or more autoencoders. In an example, the WTRU may be configured and/or indicated to start the autoencoder training process for the indicated autoencoder from one or more configured autoencoders. The indication may be based on one or more of SIB, RRC, MAC-CE and/or DCI. Depending on the value of the indicated and/or configured autoencoder training, the WTRU may determine a procedure for receiving, training, and/or downloading the encoder. For example, one of the following example conditions may apply.

For instance, one of the conditions may be “Autoencoder Training=WTRU-Trained”. For example, the WTRU may be configured and/or indicated to train the autoencoder, where the autoencoder training parameter may be determined, indicated, and/or configured to WTRU-Trained. As such, the WTRU may use the quality parameters (e.g., measured and/or predicted) for training the autoencoder. The WTRU may use the same quality parameters as input to the autoencoder model as well as the labeled values for unsupervised training of the autoencoder. In an example, the WTRU may continue training until an indicated and/or configured criteria is met. The WTRU may then stop training the autoencoder and indicate (e.g., to gNB) that the newly trained autoencoder is ready. In an example, the criteria for ending the training process may be based on a fixed number of training cycles, a threshold value for the validation loss function, etc. In an example, the WTRU may or may not apply pre-processing during the training process depending on the indicated and/or configured type of autoencoder (e.g., “Autoencoder without preprocessing”, “Autoencoder with gNB-configured threshold”, and/or “Autoencoder with WTRU-indicated threshold”). In an example, the WTRU may train the autoencoder model using a determined, indicated, and/or configured range of values for preprocessing parameters such as “Threshold”, “Max Number of Beams”, and/or “Autoencoder Mask Value”. In an example, after the training process is complete, the WTRU may store the trained autoencoder model as well as the conditions under which the autoencoder was trained (e.g., training conditions). In an example, the training conditions may include the autoencoder type (e.g., “Autoencoder without preprocessing”, “Autoencoder with gNB-configured threshold”, and/or “Autoencoder with WTRU-indicated threshold”), the range of “Threshold” values and “Max Number of Beams” used during the training, “Autoencoder Mask Value”, the size of latent vector, and the autoencoder training parameter (e.g., WTRU-Trained). In an example, after the training process is complete, the WTRU may indicate (e.g., to gNB) the information about the trained autoencoder and/or the corresponding training conditions. In an example, the WTRU may receive an indication and/or configuration for an identification value assigned (e.g., by gNB) to the trained autoencoder. In an example, the WTRU may store the assigned autoencoder identification together with the autoencoder information (e.g., autoencoder model and training conditions). In an example, the WTRU may receive an indication and/or configuration (e.g., from gNB) to use a WTRU-trained autoencoder for beam reporting using corresponding assigned autoencoder identification value. As such, the WTRU may load the stored autoencoder and/or indicate the decoder module of the autoencoder model to the gNB. The WTRU may then start using the encoder module of the indicated and/or configured autoencoder to encode the quality parameters (e.g., measured and/or predicted).

For instance, one of the conditions may be “Autoencoder Training=gNB-Trained”. For example, the WTRU may receive the encoder module of a gNB-trained autoencoder (e.g., from gNB). The WTRU may start using the received encoder module of a gNB-trained autoencoder model to encode the quality parameters (e.g., measured and/or predicted).

For instance, one of the conditions may be “Autoencoder Training=Shared-Dataset”. For example, the WTRU may be configured and/or indicated to train the autoencoder, where the autoencoder training parameter may be determined, indicated, and/or configured to “Share-Dataset”. As such, the WTRU may use the quality parameters (e.g., measured and/or predicted) for training the autoencoder. The WTRU may use the same quality parameters as input to the autoencoder model as well as the label values for unsupervised training of the autoencoder. In an example, the WTRU may apply an alignment and/or regularization method to ensure the alignment of the latent vectors with the model trained by gNB. In an example, the WTRU may use a legacy beam reporting method (e.g., CRI and RSRPs) to send (e.g., to gNB) the quality parameters (e.g., measured and/or predicted). The gNB may use the reported quality parameters (e.g., as Shared-Dataset) to train the corresponding gNB-side autoencoder. In an example, the WTRU may continue training until an indicated and/or configured criteria is met. The WTRU may then stop training the autoencoder and indicate (e.g., to gNB) that the new trained autoencoder is ready. In an example, the criteria for ending the training process may be based on a fixed number of training cycles, a threshold value for the validation loss function, etc. In an example, the WTRU may or may not apply pre-processing during the training process depending on the indicated and/or configured type of autoencoder (e.g., “Autoencoder without preprocessing”, “Autoencoder with gNB-configured threshold”, and/or “Autoencoder with WTRU-indicated threshold”). In an example, the WTRU may train the autoencoder model using a determined, indicated, and/or configured range of values for preprocessing parameters such as “Threshold”, “Max Number of Beams”, and/or “Autoencoder Mask Value”. In an example, after the training process in complete, the WTRU may store the trained autoencoder model as well as the conditions under which the autoencoder was trained (e.g., training conditions). In an example, the training conditions may include the autoencoder type (e.g., “Autoencoder without preprocessing”, “Autoencoder with gNB-configured threshold”, and/or “Autoencoder with WTRU-indicated threshold”), the range of “Threshold” values and/or “Max Number of Beams” used during the training, “Autoencoder Mask Value”, the size of latent vector, and the autoencoder training parameter (e.g., “Share-Dataset”). In an example, after the training process is complete, the WTRU may indicate (e.g., to gNB) the information about the trained autoencoder and the corresponding training conditions. In an example, the WTRU may receive an indication and/or configuration for an identification value assigned (e.g., by gNB) to the trained autoencoder. In an example, the WTRU may store the assigned autoencoder identification together with the autoencoder information (e.g., autoencoder model and training conditions). In an example, the WTRU may receive an indication and/or configuration (e.g., from gNB) to use a trained autoencoder for beam reporting using corresponding assigned autoencoder identification value. As such, the WTRU may load the stored autoencoder and start using the encoder module of the indicated and/or configured autoencoder to encode the quality parameters (e.g., measured and/or predicted).

For instance, one of the conditions may be “Autoencoder Training=Referenced-Autoencoder”. For example, the WTRU may be configured and/or indicated to train the autoencoder, where the autoencoder training parameter may be determined, indicated, and/or configured to “Referenced-Autoencoder”. As such, the WTRU may download the indicated and/or configured reference autoencoder. The WTRU may create a new autoencoder model which may be made up of a WTRU-determined encoder model with the decoder from the reference autoencoder. The WTRU may use the quality parameters (e.g., measured and/or predicted) for training the new autoencoder. The WTRU may use the same quality parameters as input to the autoencoder model as well as the label values for unsupervised training of the autoencoder. In an example, the WTRU may freeze the parameters of the decoder of the new autoencoder during the training process. In an example, the WTRU may continue training until an indicated and/or configured criteria is met. The WTRU may then stop training the autoencoder and indicate (e.g., to gNB) that the new trained autoencoder is ready. In an example, the criteria for ending the training process may be based on a fixed number of training cycles, a threshold value for the validation loss function, etc. In an example, the WTRU may or may not apply pre-processing during the training process depending on the indicated and/or configured type of autoencoder (e.g., “Autoencoder without preprocessing”, “Autoencoder with gNB-configured threshold”, and/or “Autoencoder with WTRU-indicated threshold”). In an example, the WTRU may train the autoencoder model using a determined, indicated, and/or configured range of values for preprocessing parameters such as “Threshold”, “Max Number of Beams”, and/or “Autoencoder Mask Value”. In an example, after the training process is complete, the WTRU may store the trained autoencoder model as well as the conditions under which the autoencoder was trained (e.g., training conditions). In an example, the training conditions may include the autoencoder type (e.g., “Autoencoder without preprocessing”, “Autoencoder with gNB-configured threshold”, and/or “Autoencoder with WTRU-indicated threshold”), the range of “Threshold” values and “Max Number of Beams” used during the training, “Autoencoder Mask Value”, the size of latent vector, and the autoencoder training parameter (e.g., “Referenced-Autoencoder”). In an example, after the training process is complete, the WTRU may indicate (e.g., to gNB) the information about the trained autoencoder and the corresponding training conditions. In an example, the WTRU may receive an indication and/or configuration for an identification value assigned (e.g., by gNB) to the trained autoencoder. In an example, the WTRU may store the assigned autoencoder identification together with the autoencoder information (e.g., autoencoder model and training conditions). In an example, the WTRU may receive an indication and/or configuration (e.g., from gNB) to use a trained autoencoder for beam reporting using its assigned autoencoder identification value. As such, the WTRU may load the stored autoencoder and start using the encoder module of the indicated and/or configured autoencoder to encode the quality parameters (e.g., measured and/or predicted).

Beam reporting using autoencoders may be implemented. In some examples, a WTRU may activate beam reporting based on the indication. For example, the WTRU may activate indicated one or more autoencoders for the associated CSI report configs (e.g., activated CSI report configs). In another solution, the WTRU may activate CSI report configs associated with one or more autoencoders. The indication may be based on one or more of RRC, MAC-CE and DCI. Based on a type of CSI report configuration, the WTRU may determine a different activation procedure. For example, the WTRU may activate periodic CSI report after application time from the indication. For semi-persistent CSI report and/or aperiodic CSI report, the WTRU may activate based on MAC-CE activation and/or DCI trigger in addition to the indication of the one or more autoencoders.

In some examples, a WTRU may determine, select, and/or choose one or more quality parameters based on one or more beam resources to be reported based on one or more conditions, events, indications, configurations, and/or threshold values. For example, the WTRU may determine, be configured, and/or be indicated to use one or more compression, encoding, etc. techniques (e.g., autoencoder) for the reporting of the quality parameters. In an example, the WTRU may report the determined quality parameters to the NW (e.g., to a gNB). In an example, the WTRU may measure, determine, predict, and/or estimate one or more quality parameters based on or more beam resources, for example, based on an AI/ML model. In an example, the WTRU may report one or more measured quality parameters for one or more beam resources from the set of set B beams. In another example, the WTRU may report one or more predicted quality parameters for one or more beam resources from the set of set A beams. The WTRU may be configured, indicated, and/or determined with one or more beam resources and/or sets of beam resources (e.g., set B) for which the determined quality may be measured, determined, predicted, estimated, etc. Herein, a beam resource may consist of a TCI state, reference signal (RS), CSI-RS, PT-RS, DMRS, and/or a SSB for downlink, an SRS resource or TCI state for uplink.

In some examples, the WTRU may receive one or more configuration information and/or indications via SIB, RRC, MAC-CE, DCI, etc. For example, a WTRU may be indicated and/or configured with one or more CSI-Resources and/or CSI-Resource Sets. The configurations and/or indications on CSI-Resources and/or CSI-Resource sets may include time and frequency resources, periodicity, CSI-RS indications, etc. In an example, a WTRU may be configured with a first set of set B beams and a second set of set A beams.

In some examples, a WTRU may be indicated and/or configured with a first set of one or more CSI-Resources and/or CSI-Resource Sets, where the WTRU may be configured and/or indicated with a corresponding first CSI-Resource configuration ID (e.g., CSI-ResourceConfigId). The WTRU may use the configured first set of CSI-Resources and/or CSI-Resource Sets for measuring one or more quality parameters based on the received CSI-RS resources (e.g., set B). In another example, the WTRU may be indicated and/or configured with a second set of one or more CSI-Resources and/or CSI-Resource Sets, where the WTRU may be configured and/or indicated with a corresponding second CSI-Resource configuration ID (e.g., CSI-ResourceConfigId). The WTRU may use the configured second set of CSI-Resources and/or CSI-Resource Sets for determining, predicting, and/or estimating one or more quality parameters (e.g., set A). For example, the WTRU may use the measured quality parameters based on the first CSI-Resources and/or CSI-Resource Sets to determine, predict, and/or estimate the quality parameters for the second CSI-Resources and/or CSI-Resource Sets.

For example, the WTRU may be configured with one or more CSI report configurations for reporting one or more quality parameters based on one or more CSI-Resources and/or CSI-Resource Sets. In an example, the CSI report configurations may include CSI-RS resources and/or resource sets to be used, the quality parameters to be reported, periodicity, grant and/or time and frequency resources for reporting the quality parameters, etc. For example, one or more of the following may apply. For instance, measured quality parameters may apply. In an example, the WTRU may be configured and/or indicated with a first CSI report configuration including one or more indications on reporting one or more measured quality parameters, for example based on one or more configured first sets of CSI-Resources and/or CSI-Resource Sets (e.g., set B). For instance, predicted quality parameters may apply. In another example, the WTRU may be configured and/or indicated with a second CSI report configuration including one or more indications on reporting one or more determined, predicted, and/or estimated quality parameters, for example based on one or more configured seconds set of CSI-Resources and/or CSI-Resource Sets (e.g., set A). For instance, combination of measured and predicted quality parameters may apply. In another example, the WTRU may be configured and/or indicated with a third CSI report configuration including one or more indications on reporting one or more measured, determined, predicted, and/or estimated quality parameters, for example based on one or more configured first and/or second sets of CSI-Resources and/or CSI-Resource Sets.

In some examples, the CSI report configurations may include indications on the format of the value to be reported for the configured and/or indicated quality parameters. For example, the WTRU may be configured and/or indicated to report the absolute values for one or more of the configured quality parameters, wherein the WTRU may report the quantized values based on determined, configured, and/or indicated quantization values. In another example, the WTRU may be configured and/or indicated to report the differential values for one or more of the configured quality parameters, wherein, for example, the WTRU may determine, be configured, and/or indicated with the reference value to be used for determining the differential values.

A WTRU may determine, be configured, and/or be indicated to use one or more autoencoders. In an example, the WTRU may be configured and/or indicated to use autoencoder for preparation, compression, etc. of one or more measured, determined, predicted, and/or estimated quality parameters to be reported. The WTRU may determine and/or receive one or more configuration information and/or indications on the autoencoders to be used. In an example, the WTRU may determine, be configured, and/or be indicated with one or more autoencoder types to be used for reporting one or more measured, determined, and/or predicted quality parameters. The WTRU may receive the indications and/or configurations on the autoencoder and the corresponding autoencoder type, for example via SIB, RRC, MAC-CE, DCI, etc. In an example, the WTRU may receive an indication on autoencoder type, where a first value may indicate autoencoder without preprocessing. The WTRU may receive an indication on autoencoder type, where a second value may indicate autoencoder to be used with one or more configured and/or indicated threshold values. The WTRU may receive an indication on autoencoder type, where a third value may indicate the autoencoder to be used with one or more threshold values that are determined by the WTRU. In an example, the WTRU may determine, be configured, and/or be indicated to use the indicated autoencoder and type of the indicated autoencoder for selecting and/or determining the quality parameters to be reported. One or more of the following example conditions may apply.

In some examples, “Autoencoder type=without preprocessing” may apply. For example, the WTRU may be configured and/or indicated to use autoencoder, where the autoencoder type may be determined, indicated, and/or configured to be without processing. As such, the WTRU may encode the quality parameters (e.g., measured and/or predicted) using the encoder module of the configured autoencoder without preprocessing. In some examples, after encoding the measured and/or predicted qualities without preprocessing, the WTRU may send the encoded quality parameters to the gNB.

In some examples, “Autoencoder type=with configured threshold” (e.g., gNB) may apply. For example, the WTRU may be configured and/or indicated to use autoencoder based on one or more indicated and/or configured threshold values. For example, the WTRU may receive the configuration on the threshold values via SIB, RRC, MAC-CE, DCI, etc., for example from a gNB. In an example, the WTRU may be configured with one or more threshold values on determined, estimated, and/or predicted received power for one or more (e.g., predicted) beam resources (e.g., from set A). In another example, the WTRU may be configured with one or more threshold values on measured received power for one or more (e.g., measured) beam resources (e.g., set B). For example, the WTRU may be configured with one or more RSRP threshold values. In an example, the WTRU may determine at least a first (e.g., best) beam, where for example, the first beam's (e.g., measured and/or predicted) received power may be the highest. The WTRU may determine one or more second beams, where the second beams'(e.g., measured and/or predicted) received power may be within the configured and/or indicated threshold value from the first beam's received power. For example, the WTRU may determine and/or select one or more second beams within (e.g., X dB) margin from the determined and/or selected first (e.g., best) beam. In an example, the WTRU may determine, be configured, and/or indicated with the maximum number (e.g., M1) of beam resources, for which the quality parameters may be reported. If the total number of beam resources is more than the configured maximum number of beam resources to be reported, the WTRU may determine and/or select the beam resources, up to the configured maximum number of beam resources, with the highest (e.g., measured and/or predicted) quality parameters from the set of all beam resources. For example, if the number of the beams in set B is more than the configured M1, the WTRU may determine M1 beams with highest qualities from the one or more beams.

In some examples, the WTRU may encode the value of one or more quality parameters of one or more determined and/or selected beam resources based on one or more conditions. For example, the WTRU may encode the measured and/or predicted quality parameters of the first (e.g. best) beam and one or more second beam resources, if the second beam resources belong to the set of determined and/or selected beam resources. For example, the WTRU may encode the value of the quality parameters of the best beam and one or more beam resources, for which the measured and/or predicted RSRP is within X dB margin from the best beam. As for the other beams for which the measured and/or predicted RSRP is not within the configured threshold margin from the first (e.g., best) beam, the WTRU may encode a (pre)determined, (pre)configured, and/or (pre)indicated value (e.g. “Autoencoder Mask Value”). For example, the WTRU may use a default value (e.g., RSRP_0) for the beams that are not within X dB margin from the best beam. Additionally and/or alternatively, the WTRU may use the (pre)configured (e.g., default) value (e.g., RSRP_0) for reporting the quality values for the beams that may not be measured. In some examples, after encoding the value of one or more quality parameters of one or more determined and/or selected beam resources, the WTRU may send the encoded quality parameters to the gNB.

In some examples, “Autoencoder type=with determined threshold” (e.g., WTRU) may apply. For example, the WTRU may be configured and/or be indicated to use autoencoder based on one or more determined threshold values. In an example, the WTRU may determine one or more threshold values on received power (e.g., RSRP) from one or more (e.g., predicted) beam resources (e.g., from set A). In another example, the WTRU may determine one or more threshold values on measured received power for one or more (e.g., measured) beam resources (e.g., set B). For example, the WTRU may determine RSRP threshold value (e.g., Y dB) within the configured (e.g., by gNB) threshold range (e.g., X1-X2 dB). In an example, the WTRU may determine at least a first (e.g., best) beam, where for example, the first beam's (e.g., measured and/or predicted) received power may be the highest. The WTRU may determine one or more second beams, where the second beam's (e.g., measured and/or predicted) received power may be within the determined threshold value from the first beam's received power. For example, the WTRU may determine and/or select one or more second beams within (e.g., Y dB) margin from the determined and/or selected first (e.g., best) beam. In an example, the WTRU may determine, be configured, and/or be indicated with the maximum number (e.g., M2) of beam resources, for which the quality parameters may be reported. If the total number of beam resources is more than the configured maximum number of beam resources to be reported, the WTRU may determine and/or select the beam resources, up to the configured maximum number of beam resources, for instance, with (e.g., measured and/or predicted) quality parameters within the determined range from the first (e.g., best) beam. For example, if the number of the beams in set B is more than the configured M2, the WTRU may determine M2 beams with highest qualities and within the Y dB range from the selected best beam.

In some examples, a WTRU may encode the value of one or more quality parameters of one or more determined and/or selected beam resources based on one or more conditions. For example, the WTRU may encode the measured and/or predicted quality parameters of the first (e.g. best) beam and one or more second beam resources, if the second beam resources belong to the set of determined and/or selected beam resources. For example, the WTRU may encode the value of the quality parameters of the best beam and one or more beam resources, for which the measured and/or predicted RSRP is within Y dB margin from the best beam. As for the other beams for which the measured and/or predicted RSRP is not within the configured threshold margin from the first (e.g., best) beam, the WTRU may encode a (pre)determined, (pre)configured, and/or (pre)indicated value (e.g. “Autoencoder Mask Value”). For example, the WTRU may use a default value (e.g., RSRP_0) for the beams that are not within Y dB margin from the best beam. Additionally and/or alternatively, the WTRU may use the (pre)configured (e.g., default) value (e.g., RSRP_0) for reporting the quality values for the beams that may not be measured.

In some examples, after successful determination of the threshold value (e.g., Y dB), and encoding of the value of one or more quality parameters of one or more determined and/or selected beam resources, the WTRU may send the encoded quality parameters to the gNB. Additionally and/or alternatively, the WTRU may indicate (e.g., to gNB) the successful determination of the threshold value (e.g., Y dB) within the configured threshold range (e.g., X1-X2 dB).

In some examples, if the determination of the threshold value is not successful, the WTRU may indicate (e.g., to gNB) that a threshold value could not be determined within the configured threshold range (e.g., X1-X2 dB). In this case, the WTRU may use a legacy beam reporting method (e.g., CRIs and RSRPs) to send the one or more quality parameters of one or more determined and/or selected beam resources.

Monitoring the performance of the autoencoder may be implemented. In some examples, the WTRU may determine the performance evaluation procedure based on the configured autoencoder training parameter. In some examples, if the value of the configured autoencoder training parameter is one of “gNB-trained”, “Shared-dataset”, and/or “Referenced-Autoencoder”, the WTRU may select a first performance evaluation procedure (e.g., gNB-side evaluation). For example, for the gNB-side evaluation procedure, the WTRU may encode (e.g., using the configured autoencoder) the values of one or more quality parameters of one or more determined and/or selected beam resources and indicate (e.g., to gNB) the encoded values. The WTRU may also indicate the values of one or more quality parameters of one or more determined and/or selected beam resources using a legacy reporting method (e.g., CRIs and RSRPs). For example, for the gNB-side evaluation procedure, the WTRU may compare the size of encoded measured/predicted qualities (e.g., the encoder output size), from the configured autoencoders and indicate (e.g., to gNB) the information about the N autoencoders with smallest encoder output size.

In some examples, if the value of the configured autoencoder training parameter is WTRU-trained, the WTRU may select a second performance evaluation procedure (e.g., WTRU-side evaluation). For example, for the WTRU-side evaluation procedure, the WTRU may use the encoder modules of one or more configured autoencoders to encode the values of one or more quality parameters of one or more determined and/or selected beam resources. The WTRU may then use the corresponding decoder modules of the one or more configured autoencoders to decode the encoded qualities. For example, for the WTRU-side evaluation procedure, the WTRU may compare the original values of one or more quality parameters of one or more determined and/or selected beam resources with the decoded qualities. The WTRU may calculate a distance metric (e.g., Mean Squared Error (MSE)) between the original values of the one or more quality parameters of one or more determined and/or selected beam resources with the decoded qualities. The WTRU may indicate (e.g., to gNB) the calculated distance metrics (e.g., MSE values) and the size of the encoder outputs for the one or more configured autoencoders. The WTRU may indicate (e.g., to gNB) a preferred autoencoder based on the performance of the one or more configured autoencoders.

In some examples, the WTRU may receive an indication (e.g., from gNB) about the autoencoder to be used (e.g., for each CSI reporting configuration) and/or a legacy reporting method to be used. For example, the WTRU may receive an indication to continue using the encoder of the current autoencoder. The WTRU may receive an indication to switch to a different autoencoder. The WTRU may receive an indication to switch to a legacy beam reporting method (e.g., CRIs and RSRPs). In one example the WTRU may activate the indicated autoencoder and/or switch to the indicated legacy beam reporting method.

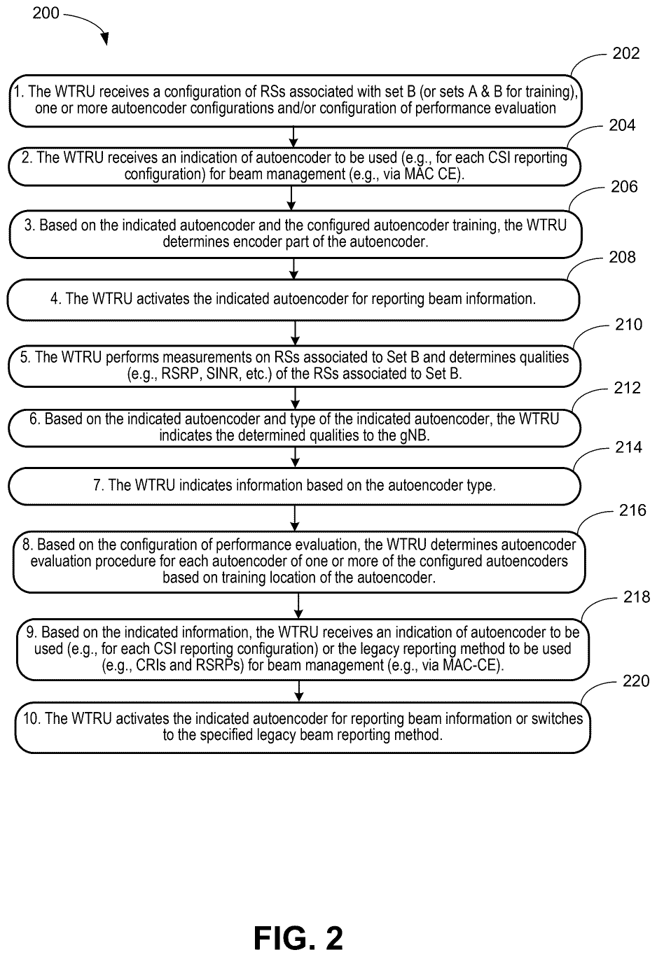

FIG. 2 is an example of a procedure 200 for using autoencoders for beam reporting. The procedure 200 may be performed by a WTRU. The procedure 200 may be start at 202. At 202, the WTRU may receive a configuration of RSs associated with set B (and/or sets A & B for training), one or more autoencoder configurations (e.g., autoencoder type, preprocessing related configuration according to the configured autoencoder type, and/or autoencoder training position) and/or configuration of performance evaluation. At 204, the WTRU may receive an indication of autoencoder to be used (e.g., for each CSI reporting configuration) for beam management (e.g., via MAC-CE). At 206, based on the indicated autoencoder and the configured autoencoder training, the WTRU may determine the encoder part of the autoencoder. For example, if “autoencoder training=WTRU-Trained”, after training the autoencoder, the WTRU may keep the encoder part and sends the decoder part of the trained autoencoder to the gNB. If the “autoencoder training=gNB-Trained”, the WTRU may receive the encoder part from gNB. If the “autoencoder training=Shared-Dataset”, after training the autoencoder (e.g., using a shared dataset and an alignment method), the WTRU may keep the encoder part (e.g., no need to send the decoder part to the gNB). If the “autoencoder training=Referenced-Autoencoder”, after training the autoencoder (e.g., using a referenced autoencoder), the WTRU may keep the encoder part (e.g., no need to send the decoder part to the gNB).

At 208, the WTRU may activate the indicated autoencoder for reporting beam information. At 210, the WTRU may perform measurements on RSs associated to Set B and may determine qualities (e.g., RSRP, SINR, etc.) of the RSs associated to Set B. At 212, based on the indicated autoencoder and/or type of the indicated autoencoder, the WTRU may indicate the determined qualities to the gNB. For example, if the “autoencoder type=without preprocessing”, the WTRU may encode the determined qualities by a given encoder without preprocessing. If the “autoencoder type=with gNB configured threshold”, the WTRU may determine a best beam and one or more beams in Set B within X dB margin from the best beam. If the “autoencoder type=with WTRU determined threshold”, the WTRU may determine a best beam and a threshold, Y dB, within the configured ranges (X1-X2 dB).

At 214, the WTRU may indicate information based on the autoencoder type. For example, If the “autoencoder type=without preprocessing” or “with gNB configured threshold”, the WTRU may indicate the encoded information. If the “autoencoder type=with WTRU determined threshold” and the WTRU determined the threshold (Y dB), the WTRU may indicate one or more of successful determinations of Y dB and/or a type of WTRU information, the determined threshold and/or the encoded information. Otherwise, the WTRU may indicate the determined qualities (e.g., RSRP, SINR, etc.) in legacy reporting methods (e.g., CRIs and RSRPs).

At 216, based on the configuration of performance evaluation, the WTRU may determine autoencoder evaluation procedure for each autoencoder of one or more of the configured autoencoders based on training location of the autoencoder. For example, if the type of autoencoder is gNB trained, the WTRU may determine a first type of performance evaluation procedure (gNB side evaluation). If the type of autoencoder is WTRU trained, the WTRU may determine a second type of performance monitoring procedure (e.g., WTRU side evaluation).

At 218, based on the indicated information, the WTRU may receive an indication of autoencoder to be used (e.g., for each CSI reporting configuration) or the legacy reporting method to be used (e.g., CRIs and RSRPs) for beam management (e.g., via MAC-CE). At 220, the WTRU may activate the indicated autoencoder for reporting beam information and/or switches to the specified legacy beam reporting method.

1. A wireless transmit/receive unit (WTRU) comprising:
a processor configured to:
receive configuration information from a network, wherein the configuration information comprises a set of reference signals (RSs) associated with a plurality of beams, an autoencoder configuration, and a channel state information (CSI) reporting configuration, wherein the autoencoder configuration comprises an autoencoder type, and wherein the autoencoder type indicates that the autoencoder is configured without preprocessing, indicates that the autoencoder is configured with a network configured threshold, or indicates that the autoencoder is configured with a WTRU-indicated threshold;
receive an indication of an autoencoder to be used for beam reporting;
determine quality parameters associated with the set of RSs; and
send a report that indicates a subset of the quality parameters to the network, wherein the subset of the quality parameters are indicated in the report based on the autoencoder and the autoencoder configuration.

2. The WTRU of claim 1, wherein, when the autoencoder type indicates that the autoencoder is configured without preprocessing, the processor is configured to indicate the subset of quality parameters in the report without preprocessing the quality parameters.

3. The WTRU of claim 1, wherein, when the autoencoder type indicates that the autoencoder is configured with a network configured threshold, the processor is configured to indicate the subset of quality parameters in the report that are associated with a subset of the plurality of beams based on the quality parameters for associated with the set of RSs and the network configured threshold.

4. The WTRU of claim 1, wherein, when the autoencoder type indicates that the autoencoder is configured with a WTRU-indicated threshold, the processor is configured to indicate the subset of quality parameters in the report that associated with a subset of the plurality of beams based on the quality parameters for associated with the set of RSs and the WTRU-indicated threshold.

5. The WTRU of claim 1, wherein the processor is configured to:
determine an autoencoder evaluation procedure for the indicated autoencoder based on a training location of the autoencoder, wherein, during the autoencoder evaluation procedure, the processor is configured to send a first indication of the subset of quality parameters based on the autoencoder and a second indication of the subset of quality parameters based on a legacy reporting method.

6. The WTRU of claim 5, wherein, during the legacy reporting method, the processor is configured to measure and report CSI reference signal resource indicator (CRI) and reference signal received power (RSRP) to the network.

7. The WTRU of claim 1, wherein the autoencoder configuration comprises an indication of a preprocessing configuration for the autoencoder type or an autoencoder training indication.

8. The WTRU of claim 1, wherein the report indicates information based on the autoencoder type.

9. The WTRU of claim 1, wherein the quality parameters comprise reference signal received power (RSRP) measurements of the set of RSs and signal-to-interference plus noise ratio (SINR) measurements of the set of RSs.

10. The WTRU of claim 1, wherein the processor is configured to receive a second indication that indicates a second autoencoder to be used for CSI reporting.

11. A method performed by a wireless transmit/receive unit (WTRU), the method comprising:
receiving configuration information from a network, wherein the configuration information comprises a set of reference signals (RSs) associated with a plurality of beams, an autoencoder configuration, and a channel state information (CSI) reporting configuration, wherein the autoencoder configuration comprises an autoencoder type, and wherein the autoencoder type indicates that the autoencoder is configured without preprocessing, indicates that the autoencoder is configured with a network configured threshold, or indicates that the autoencoder is configured with a WTRU-indicated threshold;
receiving an indication of an autoencoder to be used for beam reporting;
determining quality parameters associated with the set of RSs; and
sending a report that indicates a subset of the quality parameters to the network, wherein the subset of the quality parameters are indicated in the report based on the autoencoder and the autoencoder configuration.

12. The method of claim 11, wherein, when the autoencoder type indicates that the autoencoder is configured without preprocessing, the method further comprises indicating the subset of quality parameters in the report without preprocessing the quality parameters.

13. The method of claim 11, wherein, when the autoencoder type indicates that the autoencoder is configured with a network configured threshold, the method further comprises indicating the subset of quality parameters in the report that are associated with a subset of the plurality of beams based on the quality parameters for associated with the set of RSs and the network configured threshold.

14. The method of claim 11, wherein, when the autoencoder type indicates that the autoencoder is configured with a WTRU-indicated threshold, the method further comprises indicating the subset of quality parameters in the report that associated with a subset of the plurality of beams based on the quality parameters for associated with the set of RSs and the WTRU-indicated threshold.

15. The method of claim 11, wherein the method further comprises:
determining an autoencoder evaluation procedure for the indicated autoencoder based on a training location of the autoencoder, wherein, during the autoencoder evaluation procedure, the method further comprises sending a first indication of the subset of quality parameters based on the autoencoder and a second indication of the subset of quality parameters based on a legacy reporting method.

16. The method of claim 15, wherein, during the legacy reporting method, the method further comprises measuring and reporting CSI reference signal resource indicator (CRI) and reference signal received power (RSRP) to the network.

17. The method of claim 11, wherein the autoencoder configuration comprises an indication of a preprocessing configuration for the autoencoder type or an autoencoder training indication.

18. The method of claim 11, wherein the report indicates information based on the autoencoder type.

19. The method of claim 11, wherein the quality parameters comprise reference signal received power (RSRP) measurements of the set of RSs and signal-to-interference plus noise ratio (SINR) measurements of the set of RSs.

20. The method of claim 11, wherein the method further comprises receiving a second indication that indicates a second autoencoder to be used for CSI reporting.
